(19) United States
(12) Patent Application Publication
(10) Pub. No.: US 2014/0160466 A1
(43) Pub. Date: Jun. 12, 2014

(54) MICROPLATE READER DEVICE

(71) Applicant: ENVOLURE, Grabels (FR)

(72) Inventors: Mathieu Muller, Montpellier (FR); Florent Lorente, Beziers (FR); Yves Dudal, Hegenheim (FR)

(73) Assignee: ENVOLURE, Grabels (FR)

(21) Appl. No.: 13/777,394

(22) Filed: Feb. 26, 2013

(30) Foreign Application Priority Data
Dec. 11, 2012 (FR) 12 61887

(51) Int. Cl. G01N 21/64; G01N 21/59

(52) U.S. Cl. CPC G01N 21/64; G01N 21/59
USPC 356/72

(57) ABSTRACT

A device is provided for carrying out optical measurements such as fluorescence and absorbance measurements on samples distributed at measurement sites on a support, including first and second illumination apparatus, an optical detector, first and second optical fibres with an end facing the measurement sites at first and second faces of the support, respectively,

which device further includes optical configuration apparatus configurable so as to allow the following configurations: (i) optical coupling of the first illumination apparatus with the first optical fibres and of the optical detector with the second optical fibres, (ii) optical coupling of the second illumination apparatus and the optical detector with the second optical fibres, and/or (iii) optical coupling of the second illumination apparatus and the optical detector with the first optical fibres.

A corresponding method implemented in this device is also provided.

The present invention relates to a microplate reader device for carrying out optical measurements such as fluorescence or absorbance measurements on samples.

The field of the invention is more particularly but not exclusively that of analysis devices by optical methods for applications in the fields of environment, biology and/or chemistry.

### BACKGROUND

Techniques of optical measurement, such as fluorescence and/or absorbance measurements, are widely used in the fields of environment, biology and chemistry in particular.

It is known to condition samples to be analysed into plates comprising a plurality of wells, which ensures ease of handling and also facilitates assays. These plates can for example take the form of microplates having a standardized format with 96 wells.

These microplates are commonly used in the laboratory.

They also have the advantage to allow the production of ready-to-use analysis kits, even by non-specialist operators.

In the field of environment for example, these kits can be used to characterise waste water and/or solid waste in order to optimize the treatment and enhance value thereof.

Analysis kits can for example be provided as 96-well microplates which already contain all the reagents required for users (industrials, communities, farmers, . . . ) in charge of the treatment of effluents or waste to be capable of performing on their own, as close to their facilities as possible and in a simple, quick and economic way, the characterisation of inputs thereof. Users should simply fill wells with samples to be analysed which thereby are mixed with reagents, and insert the microplate into a microplate reader which carries out the measurements in an automated way.

For this type of applications, it is thus essential to have a suitable microplate reader.

Existing microplate readers are generally suitable for fixed uses in the laboratory or on equipped industrial sites. On the other hand, they are poorly suitable for carrying out measurements on the field or to equip minimalist industrial sites, because they are generally too bulky, heavy and require an electrical connection.

Moreover, some microplate readers can only make absorbance (in transmission) or fluorescence (in reflection) measurements, which requires the use of several equipments to carry out both types of measurements.

Conventionally, microplate readers are based on a sequential measurement principle. The microplate is moved relative to an optical measurement head, so as to position this measurement head successively facing each well. Even if some parallelism degree is sometimes introduced, these readers are still bulky, relatively slow and expensive.

Document U.S. Pat. No. 4,968,148 to Chow et al. is also known which describes a reader wherein the microplate is fixed with respect to the measurement system. The illumination system comprises a bundle of optical fibres which bring light from a source to the wells of the microplate. The detection is carried out by a plurality of detectors, one per well. This system thus only allows absorbance measurements, in transmission. Moreover, the measurement remains sequential because light is injected in the bundle fibres sequentially.

### SUMMARY

One object of the present invention is to provide a microplate reader better suited for use with analysis kits in particular, which solve the problems of prior art.

One object of the present invention is also to provide a multipurpose microplate reader which is suitable for use with a variety of reagents and/or analysis kits, which enables with minimum handling to carry out absorbance and fluorescence measurements at varying wave lengths.

Finally, one object of the present invention is to provide a compact microplate reader, suitable for mobile use possibly in electrical autonomy, robust and practical to use even by an unskilled operator.

This object is achieved with a device for carrying out optical measurements such as fluorescence and absorbance measurements on samples distributed at measurement sites on a support, comprising:
first illumination means,
optical detection means,
first optical fibres with an end facing the measurement sites at a first face of the support,

characterised in that it further comprises:
second illumination means,
second optical fibres with an end facing said measurement sites at a second face of the support opposite to the first face, and
optical configuration means configurable so as to allow the following configuration:

(i) optical coupling of the first illumination means with the first optical fibres and of the optical detection means with the second optical fibres,

and at least one of the following configurations:

(ii) optical coupling of the second illumination means and the optical detection means with the second optical fibres,

(iii) optical coupling of the second illumination means and the optical detection means with the first optical fibres.

The first face of the support can be an upper or lower face depending on the convention used.

Configuration (i) in particular enables absorbance measurements, in transmission, to be carried out.

Configuration (ii) in particular enables fluorescence measurements in reflection to be carried out, by accessing samples on the second face side of the support.

Configuration (iii) in particular enables fluorescence measurements in reflection to be carried out, by accessing samples on the first face side of the support.

According to embodiments, the optical configuration means can comprise a moving coupling element supporting the first illumination means and folding optical means, which moving coupling element is movable such that:
in a first position, the first illumination means are optically coupled with the first optical fibres, and the optical detection means are optically coupled with the second optical fibres through the folding optical means;
in a second position, the optical detection means are optically coupled with said first optical fibres through the folding optical means.

Moreover, in the second position, the first illumination means can be decoupled from the first optical fibres.

When the moving coupling element is in the first position, it is in particular possible to carry out absorbance measurements in transmission, and fluorescence measurements in reflection by accessing samples on the second face side of the support.

When the moving coupling element is in the second position, it is in particular possible to carry out fluorescence measurements in reflection by accessing samples on the first face side of the support.

According to embodiments:
the first and second optical fibres can be respectively gathered as a bundle on the optical configuration means side;
the optical detection means can comprise an array detector capable of collecting light from the first or second optical fibres;
the first illumination means can comprise a light emitting diode (LED) type source, or a plurality of light emitting diode (LED) type sources coupled by homogenising optical rod;
the optical configuration means can further comprise at least one lighting module capable of being inserted in front of the optical detection means, which module comprising second illumination means, and a partly reflective element capable of (i) transmitting at least one part of the light from said second illumination means to the coupling means and (ii) transmitting at least one part of the light from the coupling means to the optical detection means;
the partly reflective element can comprise a dichroic element;
the second illumination means can comprise a light emitting diode (LED) type source, or a plurality of light emitting diode (LED) type sources coupled by homogenising optical rod;
the device according to the invention can comprise a plurality of lighting modules, and means for changing or withdrawing the lighting module inserted in front of the optical detection means.

According to embodiments:
the device according to the invention can be suitable for use of 96-well microplate type supports making up the measurement sites. It can in particular be suitable for use of 96-well microplate type supports being opaque, transparent, opaque with a transparent bottom, plate, conical or rounded bottom, of polystyrene, polypropylene, glass or any other material;
the device according to the invention can be suitable for use of 6-, 12-, 24-, 48-, 96- and/or 384-well microplate type supports, in any material, any colour and any shape;
the device according to the invention can be suitable for use of plates with deep wells, of the “deepwell” type.

It can further comprise means for identifying microplates from predefined kits.

The device according to the invention can further comprise:
means for stirring the support and/or means for heating the support;
battery type stand-alone power supply means.

According to another aspect, it is provided a method for carrying out optical measurements such as fluorescence and absorbance measurements on samples distributed at measurement sites on a support, implementing first illumination means, optical detection means, first optical fibres with an end facing the measurement sites at a first face of the support, second illumination means, second optical fibres with an end facing said measurement sites at a second face of the support opposite to the first face, and optical configuration means,

which method comprises operations for configuring the optical configuration means, so as to carry out the following configuration:

(i) optical coupling of the first illumination means with the first optical fibres and of the optical detection means with the second optical fibres,

and at least one of the following configurations:

(ii) optical coupling of the second illumination means and the optical detection means with the second optical fibres,

(iii) optical coupling of the second illumination means and the optical detection means with the first optical fibres.

According to embodiments, in particular to carry out absorbance measurements, the method according to the invention can comprise the steps of:
illuminating the samples by means of the first illumination means coupled in the first optical fibres, and
measuring with the optical detection means light transmitted through the samples and coupled in the second optical fibres.

According to embodiments, in particular to carry out fluorescence measurements, the method according to the invention can comprise the steps of:
illuminating at an excitation wavelength the samples by means of the second illumination means coupled in the first or second optical fibres,
measuring with the optical detection means the light from fluorescence of samples and coupled in the same first or second optical fibres.

Thus, the invention allows making a device such as microplate reader which is compact, easy to use and suitable for use on the field, possibly in electrical autonomy:
the illumination of samples in microwells and light collection are simultaneously carried out, in parallel, by virtue of the implementation of the first and second optical fibres. Further, the acquisition of measurements is quick;
the measurement does not require movements of the microplate relative to the measurement system, which enables the compactness of the system and its energy consumption to be dramatically improved. Using optical fibres also enables compactness to be improved;
the detection can be carried out for all the measurement channels simultaneously on a single array detector (for example CCD), which enables cost and complexity to be reduced;
the architecture of the system enables, with minimum moving components, to make a variety of configurations, to be readily adaptable to a variety of measurement situations;
this adaptation can be automatically performed, according to pre-set recipes or protocols, which enables an implementation even by unskilled operators.

### BRIEF DESCRIPTION OF THE DRAWINGS

Further advantages and features of the invention will appear upon reading the detailed description of embodiments and implementations in no way limiting, and the following appended drawings in which:

FIG. 1 illustrates a schematic view of a device according to the invention, according to a first measurement configuration to carry out fluorescence measurements by a first face of the samples,

FIG. 2 illustrates a schematic view of a device according to the invention, according to a second measurement configuration to carry out fluorescence measurements by a second face of the samples,

FIG. 3 illustrates a schematic view of a device according to the invention, according to a third measurement configuration to carry out absorbance measurements in transmission,

FIG. 4 illustrates a top view of an embodiment of the device according to the invention.

### DETAILED DESCRIPTION

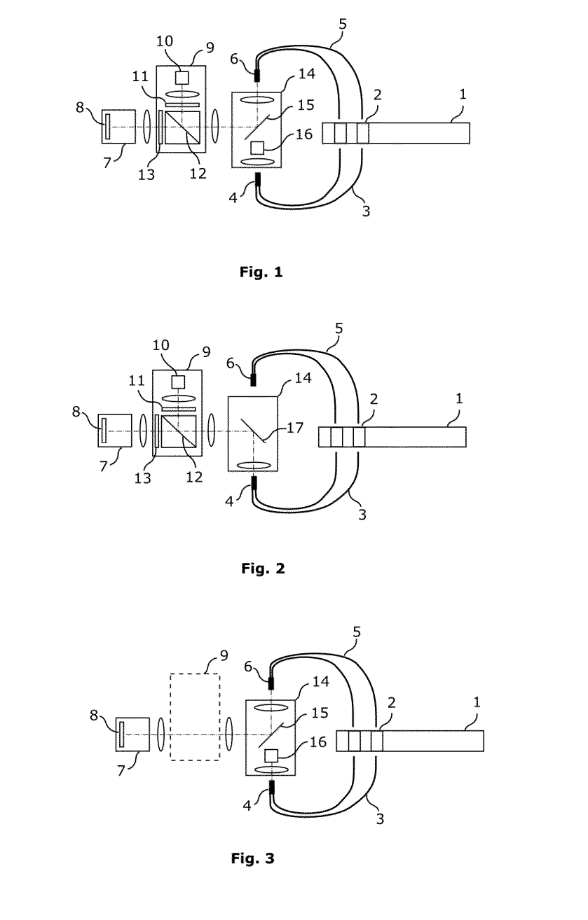

An embodiment of the device according to the invention made as a 96-well microplate reader will now be described in reference to FIGS. 1 to 4.

These microplates 1 have standardized dimensions and comprise 96 wells 2 or cavities intended to accommodate samples to be measured, possibly mixed with reagents. Depending on the models, the wells 2 can have opaque or transparent bottoms.

The device according to the invention comprises a housing or drawer 20 for receiving a microplate 1.

This housing comprises mechanical stirring means for stirring the microplate 1 and mixing products in the wells, with a motor for moving them. It also comprises heating means with electrical resistors for heating the microplate 1, for example in order to carry out incubations or to maintain products to analyse under accurate temperature conditions.

The device according to the invention is designed such as to allow the following optical measurements:
measurements in transmission through the wells 2, which enables absorbance and optical densities (OD) measurements to be carried out in particular;
measurements in backscattering, which enables in particular fluorescence measurements to be carried out on samples contained in the wells 2.

The device according to the invention is further designed such as to allow the performance of measurements in back scattering from both faces of the microplate 1, in order to be adaptable to a variety of measurement conditions.

According to a particularly novel aspect, the device according to the invention comprises two bundles of multimode optical fibres 3, 5 which allow to direct light to samples and/or to collect light from these samples simultaneously, for all the wells 2 considered, without requiring a relative displacement of the microplate 1 and the measurement system.

A first bundle of optical fibres 3 is provided at a first face of the microplate 1. It comprises first multimode optical fibres 3 gathered as a bundle at a proximal end 4 to be coupleable to the optical system, and the opposite or distal ends of which are distributed at the surface of the microplate, each facing a well 2.

A second bundle of multimode optical fibres 5 is provided at a second face of the microplate 1 opposite to the first face. It comprises second optical fibres 5 gathered as a bundle at a proximal end 6 to be coupleable to the optical system, and the opposite or distal ends of which are distributed at the surface of the microplate, each facing a well 2.

The distal ends of the first optical fibres 3 and second optical fibres 5 are placed facing each other, on either side of the locations of the wells 2 of the microplate 1 when the same is in measurement position in its housing or drawer 20. They are maintained in position by a fibre support 23, and are provided with collimation optics, so as to allow an optical coupling through the well 2 of light from an optical fibre in the opposite optical fibre.

The fibre supports 23 are designed so as to ensure a positioning of the optical fibres in front of the wells 2 when the microplate 1 is in measurement position. These fibre supports 23 also support the collimation optics.

It should be noted that in FIGS. 1 to 3, only two first and second optical fibres 3, 5 and two wells 2 are represented for the sake of clarity, but it is understood that the device comprises at least as many first optical fibres 3 and as many second optical fibres 5 as the microplate 1 comprises wells 2 to be simultaneously analysed.

According to embodiments, the device according to the invention can comprise a plurality of first optical fibres 3 and/or a plurality of second optical fibres 5 in front of each well 2.

According to another novel aspect, the device according to the invention comprises a single array detector 8, as a camera 7 with a CCD detector 8, which is usable in all the measurement configurations.

The device according to the invention also comprises an imaging optical system, in particular comprised of lenses, which enables the end of the first optical fibres 3 or second optical fibres 5 to be imaged, depending on the configuration, onto the CCD detector 8. Thus, signals from the wells 2 of the microplate 1 are imaged onto the detector 8 at different positions on its surface, which enables them to be simultaneously detected by discriminating them with respect to each other. Light from each fibre of the first optical fibres 3 or second optical fibres 5 thus forms a spot at a distinct position at the surface of the CCD detector 8. The position at the surface of the CCD detector 8 of the spot corresponding to each fibre and thus to each well 2 can be determined in a prior step of calibrating the detector 8. It can also be determined, or refined, from an analysis of the image formed on the surface of the CCD detector 8 by all the spots.

As previously explained, the device according to the invention enables measurements to be carried out according to several measurement modes, including absorbance measurements in transmission and fluorescence measurements in reflection by either face of the microplate 1.

The selection of the measurement mode is carried out by configuring the optical system, by means of two moving elements:
moving optical coupling means 14, which in particular enable the bundle of optical fibres coupled with the camera 7 to be selected, and which comprise first illumination means 16;
a lighting module 9, inserted between the camera 7 and the moving optical coupling means 14, and which comprises second illumination means 10.

Thus, it is possible to make all the useful optical configurations with minimum moving elements.

The moving optical coupling means 14 comprise a first carriage 21 which is translationally movable between two positions:
in a first position, that is the configuration of FIGS. 1 and 3: the camera is optically coupled with the fibres of the second bundle of fibres 5 through a mirror 15, and the first illumination means 16 are optically coupled with the fibres of the first bundle of optical fibres 3;
in a second position, that is the configuration of FIG. 2: the camera is optically coupled with the fibres of the first bundle of fibres 3 through another mirror 17.

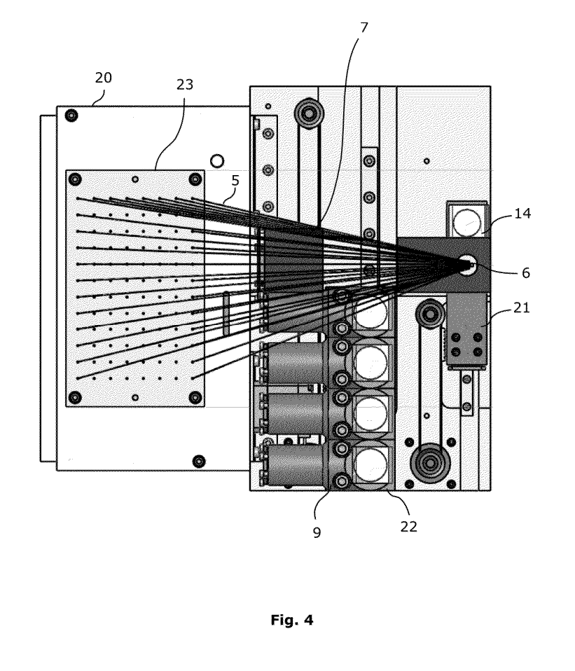

The device according to the invention further comprises a second moving carriage 22 capable of accommodating a plurality of lighting modules 9. By translationally moving this second carriage 22, the lighting module 9 inserted between the camera 7 and the moving optical coupling means 14 can thus be changed, or, depending on the configuration illustrated in FIG. 4, no module 9 or empty module 9 can be inserted.

More precisely, in the configuration illustrated in FIG. 4, the second moving carriage 22 comprises four lighting modules 9 and an empty location. It is represented positioned such that the empty location is between the camera 7 and the moving optical coupling means 14.

It should be noted that the camera 7 and the ends of the first optical fibres 3 and of the second optical fibres 5 are fixed with respect to the device. All the measurement configurations can be obtained by moving the moving optical coupling means 14 and/or the carriage 22 which supports the lighting modules 9.

FIG. 1 illustrates a first measurement configuration of the device according to the invention, which enables fluorescence measurements to be carried out through second optical fibres 5.

The moving optical coupling means 14 are placed in a position which allows coupling with the fibres of the second bundle of fibres 5. The first illumination means 16 are OFF.

A lighting module 9 is inserted in front of the camera 7. It comprises a light source 10 with at least one light emitting diode (LED) which emits a light at least one excitation wavelength. An excitation optical filter 11 placed in front of this source 10 enables excitation wavelengths to be selected.

The light from the source is directed by a dichroic element 12 to the proximal end 6 of the second optical fibres 5, so as to simultaneously illuminate all the samples in the wells 2. The fluorescence generated at the samples is also sensed by the second optical fibres 5, in back scattering, and directed to the detector 8 of the camera 7. The dichroic element 12 ensures transmission of the light at fluorescence wavelengths to the camera 7. An emission optical filter 13 placed in front of this camera 7 blocks wavelengths other than the wavelengths of interest.

The lighting modules 9 can be suitable for use for example with particular reagents. Thus, by changing the lighting module 9, the samples can for example be illuminated at different excitation wavelengths and fluorescence measurements can also be made at different wavelengths.

The lighting modules 9, or at least some of them, can comprise several LED type sources, which allows with a module 9 to be able to carry out lightings at several wavelengths by selectively switching ON the sources. The sources can be coupled through a homogenising optical rod which outputs a homogeneous illumination regardless of the source implemented.

A homogenising optical rod is a transparent glass element having a hexagonal or square cross-section. Light sources are coupled to an end of the rod. Because of the multiple internal reflections in the rod, a light with a good spatial homogeneity is obtained at the other end of the rod, even if the coupled light sources are poorly homogeneous.

FIG. 2 illustrates a second configuration of measurement of the device according to the invention, which enables fluorescence measurements to be carried out through the first optical fibres 3.

This measurement configuration differs from the measurement configuration of FIG. 1 in that the moving optical coupling means 14 are placed in a position which allows coupling with the fibres of the first bundle of fibres 3.

It is thus possible to carry out fluorescence measurements from the front or back face of the microplate, as a function of the implementation constraints.

FIG. 3 illustrates a third measurement configuration of the device according to the invention, which enables absorbance measurements to be carried out, in transmission.

The moving optical coupling means 14 are placed in a position which allows coupling of the camera 7 with the fibres of the second bundle of fibres 5, and the coupling of the first illumination means 16 with the fibres of the first bundle of optical fibres 3.

The first illumination means 16 comprise a light emitting diode (LED) type light source or, dependent on the embodiments, several light emitting diode (LED) type light sources coupled on a homogenising optical rod which outputs a homogeneous illumination regardless of the source implemented.

The presence of several sources enables absorbance measurements to be carried out at different wavelengths, by selectively switching ON the sources.

Light from the source 16 is simultaneously guided to the samples in the wells 2 by the first optical fibres 3. Light which passes through the samples is collected by the second optical fibres 5 and brought to the array detector 8.

In this configuration, there is no lighting module 9 inserted in front of the camera 7. There can however be possibly a lighting module 9 left in place, provided that it is compatible as regards its spectral characteristics and that the second source 10 is switched OFF.

According to a non-limiting configuration example, the device according to the invention comprises first illumination means 16 with five LED type light sources coupled on a homogenising rod, and a location for a sixth LED. These light sources can be individually switched ON to carry out absorbance measurements in transmission according to the configuration of FIG. 3, without lighting module 9 in the optical circuit. The wavelengths of the light sources and the intended applications (or targeted chromophores) are summarised in the following table:

| LED | Intended application or targeted chromophore |
|---|---|
| 450 nm | phosphovanadomolybdic complex (Misson assay) |
| 540 nm | Azo aromatic compound (Griess assay) |
| 405 nm | para-nitrophenol (Reaction product of phosphatase on the |
| | para-nitrophenyl phosphate - pNPP substrate) |
| 600 nm | Malachite green |
| 630 nm | Turbidity and various precipitates |

According to the same example configuration, the device according to the invention comprises three lighting modules 9 mounted on the second moving carriage 22. This second moving carriage 22 further comprises a location for a fourth lighting module 9 and an empty location to allow absorbance measurements.

Each lighting module 9 comprises a source 10 with a single LED, as well as an excitation filter 11, a dichroic blade 12 and an emission filter 13 being adapted.

The lighting modules 9 enable fluorescence measurements to be carried out according to the configurations of FIG. 1 or 2. Wavelengths of the light sources 10 and targeted fluorophores are summarised in the following table:

| LED | Fluorophore |
|---|---|
| 540 nm | Resazurin |
| 420 nm | Isoindole (Roth assay) |
| 340 nm | N-(1-naphthyl)ethylenediamine |

Further, the device according to the invention is designed such that the sources 10 of the lighting modules 9 can accommodate up to three LEDs:
these LEDs can be thus multiplexed in a same lighting module 9 with a wideband excitation filter 11, and be independently activated in order to detect, with a same lighting module 9, several fluorophores excited at different wavelengths but which emit at a same wavelength;
these LEDs can also be multiplexed in a same lighting module 9 with multiband excitation 11 and emission 13 filters to detect, with a single lighting module 9, several fluorophores excited at different wavelengths and emitting at wavelengths which are also different.

Thus, it is possible to make configurations enabling up to 3×4=12 different fluorophores to be detected with a same device using three LEDs multiplexed for each source 10 and three-band excitation 11 and emission 13 filters on each of the four lighting modules 9.

As previously explained, a device according to the invention can be made such that it can be implemented with any kind of microplate, assuming obvious adaptations for those skilled in the art.

The device according to the invention is particularly suitable for implementing measurement kits wherein microplates, for example having 96 wells, are provided with required reagents. In this case, a non-limiting exemplary measurement protocol could be the following one:
the operator fills the 96 wells of the microplate;
he inserts it into the drawer 20 of the microplate reader;
he parameterises the reader, by selecting the analysis type and/or the kit. Alternatively, the kits could be provided with an identifying means (bar code, RFID chip) enabling the reader to identify them and to be automatically parameterised;
the reader possibly conducts stirring to mix the samples with reagents;
the instrument then possibly conducts culturing via the thermal cycling.
Then, an optical analysis is performed by means of one or more previously described measurement configurations;
the processing gives back 96 fluorescence and/or absorbance measurements of the sample. These measurements are converted into sample concentration (linear or polynomial response), for example by use of a calibration curve predefined for each kit;
a delay or timing can possibly be introduced before or in between different steps (incubation, stirring, reading . . . );
the different steps can be alternatively repeated in order to perform kinetics on a defined period of time.

According to alternative embodiments, the device according to the invention can comprise interchangeable drawer housings 20 adapted to different types of microplates 1, in particular with different numbers of wells. It can also comprise interchangeable fibre supports 23, also adapted to particular arrangements of the plates 1. In this case, the bundles of first and second fibres 3, 5 can also be interchangeable.

According to alternative embodiments, the device according to the invention can be designed such that the first optical fibres 3 are positioned on the lower face side of the microplate 1, thus in front of the bottom of the wells 2. Alternatively, the device according to the invention can be designed such that the first optical fibres 3 are positioned on the upper face side of the microplate 1, thus in front of the opening of the wells 2. Of course, in both cases, the second optical fibres 5 are positioned on the side of the face opposite to the microplate 1 relative to the first optical fibres 3.

Of course, the invention is not restricted to the examples just described and numerous alterations can be provided to these examples without departing from the scope of the invention.

1. A device for carrying out optical measurements such as fluorescence and absorbance measurements on samples distributed at measurement sites on a support, comprising:
first illumination means;
optical detection means;
first optical fibres with an end facing the measurement sites at a first face of the support;
second illumination means;
second optical fibres with an end facing said measurement sites at a second face of the support opposite to the first face; and
optical configuration means configurable so as to allow the following configuration:
(i) optical coupling of the first illumination means with the first optical fibres and of the optical detection means with the second optical fibres,
and at least one of the following configurations:
(ii) optical coupling of the second illumination means and the optical detection means with the second optical fibres, and
(iii) optical coupling of the second illumination means and the optical detection means with the first optical fibres.

2. The device according to claim 1, wherein the optical configuration means comprise a moving coupling element supporting the first illumination means and folding optical means, which moving coupling element is movable such that:
in a first position, the first illumination means are optically coupled with the first optical fibres, and the optical detection means are optically coupled with the second optical fibres through the folding optical means;
in a second position, the optical detection means are optically coupled with said first optical fibres through the folding optical means.

3. The device according to claim 1, wherein the first and second optical fibres are respectively gathered as a bundle on the optical configuration means side.

4. The device according to claim 1, wherein the optical detection means comprise an array detector capable of collecting light from the first or second optical fibres.

5. The device according to claim 1, wherein the first illumination means comprise a light emitting diode (LED) type source, or a plurality of light emitting diode (LED) type sources coupled by a homogenising optical rod.

6. The device according to claim 1, wherein the optical configuration means further comprise at least one lighting module capable of being inserted in front of the optical detection means, which module comprising second illumination means, and a partly reflective element capable of (i) transmitting at least one part of the light from said second illumination means to the coupling means and (ii) transmitting at least one part of the light from the coupling means to the optical detection means.

7. The device according to claim 6, wherein the partly reflective element comprises a dichroic element.

8. The device according to claim 6, wherein the second illumination means comprise a light emitting diode (LED) type source, or a plurality of light emitting diode (LED) type sources coupled by a homogenising optical rod.

9. The device according to claim 6, which comprises a plurality of lighting modules, and means for changing or withdrawing the lighting module inserted in front of the optical detection means.

10. The device according to claim 1, which is suitable for use of 96-well microplates type supports making up the measurement sites.

11. The device according to claim 10, which further comprises means for identifying microplates from predefined kits.

12. The device of claim 1, which further comprises means for stirring the support and/or means for heating the support.

13. The device of claim 1, which further comprises battery type stand-alone power supply means.

14. A method for carrying out optical measurements such as fluorescence and absorbance measurements on samples distributed at measurement sites on a support, implementing first illumination means, optical detection means, first optical fibres with an end facing the measurement sites at a first face of the support, second illumination means, second optical fibres with an end facing said measurement sites at a second face of the support opposite to the first face, and optical configuration means,
comprising operations for configuring the optical configuration means, so as to carry out the following configuration:
(i) optical coupling of the first illumination means with the first optical fibres and of the optical detection means with the second optical fibres,
and at least one of the following configurations:
(ii) optical coupling of the second illumination means and the optical detection means with the second optical fibres, and
(iii) optical coupling of the second illumination means and the optical detection means with the first optical fibres.

15. The method according to claim 14 for carrying out absorbance measurements, which comprises the steps of:
illuminating the samples by means of the first illumination means coupled in the first optical fibres,
measuring with the optical detection means light transmitted through the samples and coupled in the second optical fibres.

16. The method according to claim 14 for carrying out fluorescence measurements, which comprises the steps of:
illuminating at an excitation wavelength the samples by means of the second illumination means coupled in the first or second optical fibres,
measuring with the optical detection means the light from fluorescence of samples and coupled in the same first or second optical fibres.
